(19) United States
(12) Patent Application Publication
(10) Pub. No.: US 2025/0111751 A1
(43) Pub. Date: Apr. 3, 2025

(54) GAMING DEVICE WITH CLONING REEL SUBSET AND EXPANDING REEL SUBSET

(71) Applicant: Aristocrat Technologies, Inc., Las Vegas, NV (US)

(72) Inventors: Riddhi Patel, Las Vegas, NV (US); Adam Bland, Henderson, NV (US)

(21) Appl. No.: 18/624,599

(22) Filed: Apr. 2, 2024

Related U.S. Application Data
(60) Provisional application No. 63/541,153, filed on Sep. 28, 2023.

(51) Int. Cl. G07F 17/32

(52) U.S. Cl. CPC G07F 17/3267; G07F 17/3213

(57) ABSTRACT

A gaming system includes a processor and a memory storing instructions thereon which, when executed by the processor, cause the processor to: control a display device to display a play instance of an electronic game including a first subset of reels and a second subset of reels; cause display of a first set of symbols on the first subset of reels; determine that a first trigger condition stored in the memory is satisfied based on the first set of symbols, where the first trigger condition is a pre-defined symbol type appearing on each reel of the first subset of reels; and randomly determine whether to cause display of the same symbols on each reel of the first subset of reels.

### CROSS-REFERENCE TO RELATED APPLICATION(S)

This application claims priority to U.S. Provisional Patent Application No. 63/541,153, filed Sep. 28, 2023, the disclosure of which is hereby incorporated by reference in its entirety.

### TECHNICAL FIELD

The field of disclosure relates generally to electronic gaming devices, systems and methods that provide a reel set including a first subset of reels that may be selectively cloned based on a first trigger condition and a second subset of reels that may selectively expand based on a second trigger condition.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### BRIEF DESCRIPTION

In one aspect, a gaming system is provided. The gaming system includes a processor and a memory storing instructions thereon. The instructions, when executed by the processor, cause the processor to: control a display device to display a play instance of an electronic game including a first subset of reels and a second subset of reels; cause display of a first set of symbols on the first subset of reels; determine that a first trigger condition stored in the memory is satisfied based on the first set of symbols, where the first trigger condition is a pre-defined symbol type appearing on each reel of the first subset of reels; and randomly determine whether to cause display of the same symbols on each reel of the first subset of reels. The instructions may direct additional, less, and/or alternative functionality, including that which is described below.

In another aspect, a non-transitory computer-readable medium containing instructions stored thereon is provided. The instructions, when executed by a processor, cause the processor to: control a display device to display a play instance of an electronic game including a first subset of reels and a second subset of reels; control the display device to display a first set of symbols on the first subset of reels; determine that a first trigger condition stored in memory is satisfied based on the first set of symbols, where the first trigger condition is a pre-defined symbol type appearing on each reel of the first subset of reels; and randomly determine whether to control the display device to display the same symbols on each reel of the first subset of reels. The instructions may direct additional, less, and/or alternative functionality, including that which is described below.

In another aspect, a computer-implemented method is provided. The computer-implemented method includes: controlling a display device to display a play instance of an electronic game including a first subset of reels and a second subset of reels; controlling the display device to display a first set of symbols on the first subset of reels; determining that a first trigger condition stored in memory is satisfied based on the first set of symbols, where the first trigger condition is a pre-defined symbol type appearing on each reel of the first subset of reels; and randomly determining whether to control the display device to display the same symbols on each reel of the first subset of reels. The computer-implemented method may include additional, less, and/or alternative actions, including those described below.

### BRIEF DESCRIPTION OF THE DRAWINGS

FIG. 1 is an exemplary diagram showing several gaming machines networked with various gaming related servers.

FIG. 2A is a block diagram showing various functional elements of an exemplary gaming machine.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIGS. 4A and 4B are a flow chart of a process for executing a game instance of an electronic game for display to a user on a gaming device similar to the gaming device of FIG. 1.

FIG. 5 is an example user interface or screen display showing display of an outcome of a first game instance according to the process of FIGS. 4A-4B.

FIG. 6 is an example user interface or screen display showing display of an outcome of a second game instance according to the process of FIGS. 4A-4B.

FIG. 7 is an example user interface or screen display showing display of an outcome of a third game instance according to the process of FIGS. 4A-4B.

FIG. 8 is an example user interface or screen display showing display of an outcome of a fourth game instance according to the process of FIGS. 4A-4B.

FIG. 9 is an example user interface or screen display showing display of an outcome of a fifth game instance according to the process of FIGS. 4A-4B.

FIG. 10 is an example user interface or screen display showing display of an outcome of a sixth game instance according to the process of FIGS. 4A-4B.

FIGS. 11A-11D depict a sequence of screen displays showing a spin and stop sequence according to the process of FIGS. 4A-4B.

FIG. 12 is an example user interface or screen display showing display of an outcome of a seventh game instance according to the process of FIGS. 4A-4B.

FIGS. 13-15 are transitional screens between a base game shown in FIGS. 5-12 and a bonus game triggered by the outcome of FIG. 12.

FIGS. 16-22 are various screen displays depicting bonus game play of the electronic game.

Corresponding reference numerals used throughout the drawings indicate corresponding elements.

### DETAILED DESCRIPTION

Example embodiments described herein relate to systems and methods for providing an electronic game that includes a cloning reel subset and an expanding reel subset. The features of the different reel subsets are controlled by different random number generator (RNG) and/or lookup operations and provide a distinct multi-feature game mechanic during base game play.

The cloning feature of the first reel subset increases the chances of landing feature symbols (e.g., WILD symbols or bonus game symbols) on the reels of the first subset. The WILD symbols may trigger the expanding reel feature of the reels of the second subset when they land on each reel of the first subset. The bonus game symbols may trigger a bonus or feature game when a triggering number of the bonus game symbols land in any reel of the first or second subsets. For the cloning feature, an RNG may control the outcome of when the first reel subset will be cloned. When cloned, the symbols displayed each reel of the first subset are the same, thereby increasing the probability of landing WILD symbols on each reel of the first subset and/or landing multiple bonus game symbols to reach or near the triggering number.

When each of the reels of the first subset land WILD symbols, an expandable game feature is triggered for the reels of the second subset. The expandable reel feature may be based on a separate RNG which is triggered when WILD symbols have landed on each reel of the first subset. The expandable reels feature may be independent of whether the WILD symbols that landed on the reels of the first subset were the result of cloned reels, or otherwise (e.g., independently determined stopping positions). When the expandable reel feature is triggered, the rows of the reels of the second subset vertically expand to an increased number of rows. Increasing the number of rows (the vertical height) of the reels of the second subset increases the chances of winning symbol combinations and/or winning symbols that appear in a spin outcome. The increased height of the reels of the second subset may vary and may be determined based on the outcome of an RNG. In the event that the RNG determines vertical expansion of the reels of the second subset to a tallest possible height, a check may be performed to ensure that the win value of the outcome meets some predefined win conditions to ensure that the tallest height option only provides high value or exciting game outcomes. In the event that the check fails at the tallest height, because the win value is lower than some threshold or not enough feature symbols will land in the outcome, for example, the game mechanic may reduce the expansion of the reel of the second subset to a shorter height or smaller number of rows. However, a player may be guaranteed some increase in vertical height when the expandable reels feature is triggered.

In example implementations, the expandable reels feature does not guarantee that the player of the game wins anything. While the reels of the second subset may expand to taller heights, the reels themselves still must generate winning symbols combinations or winning symbols (e.g., cash-on-reel or COR symbols) controlled by a subsequent RNG for the player to win by satisfying pre-defined win conditions. The electronic game may also include COR symbols that have dynamically determined credit values, and payout of the credit values may be controlled based on one or more predefined conditions or prerequisites during base game play. For example, the expandable reels feature may need to be triggered and the COR symbols must land in left-to-right arrangement in order to be paid out. The left-to-right arrangement requirement may enable the game to use separate pay tables for COR symbols landing on separate reels, and vary the frequency at which the COR symbols appear during base game play without having the pay out the credit values each time a COR symbol appears.

The technical problems addressed herein include at least one of: (i) inability of known systems to implement a multi-feature game mechanic during a base game mode that includes cloning reels and expanding reels; (ii) inability of known systems to efficiently and effectively communicate a status of each feature of the multi-feature game mechanic while maintaining or reducing computing resources required to do so; (iii) inability of known systems to implement an expanding reel subset feature in conjunction with progressively increasing cash on reel symbols that appear on the expanded reels while controlling payout volatility and RTP; (iv) inability of known systems to maintain or improve use of computational resources while implementing the multi-feature game mechanic; and/or (v) inability of known systems to implement an expanding reel subset feature using a win condition check to control a degree of growth of the expanding reel subset.

The resulting technical effects and/or technical benefits achieved by this disclosure include at least one of: (i) ability to provide an electronic game having a multi-feature game mechanic that includes a first, potentially cloning reel subset and a second, potentially expanding reel subset; (ii) provision of multiple different determinations and trigger conditions to implement the multi-feature game mechanic; (iii) provision of additional trigger conditions for paying out cash on reel symbols on the expanded reel subset; (iv) provision of particular controls on cash on reel payouts that allow for the cash on reel symbols to progressively increase in value across the expanded reel subset; (v) implementation of a win condition check to control growth of the expanded reel subset to ensure that a tallest possible reel height is reserved for certain win conditions; (vi) ability to efficiently and effectively communicate a status of each feature of the electronic game on a limited display area and without requiring additional computational resources; and (vii) increasing flexibility and versatility of the electronic games described herein in conjunction with efficient computational design and maintained and/or improved use of computational resources.

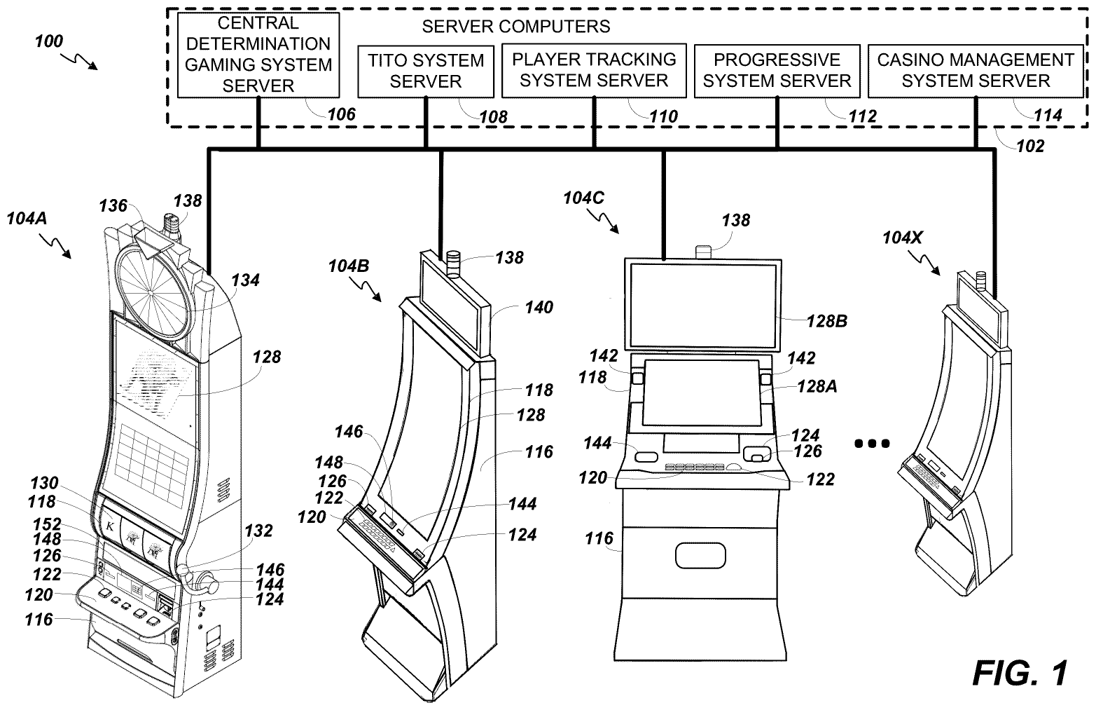

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

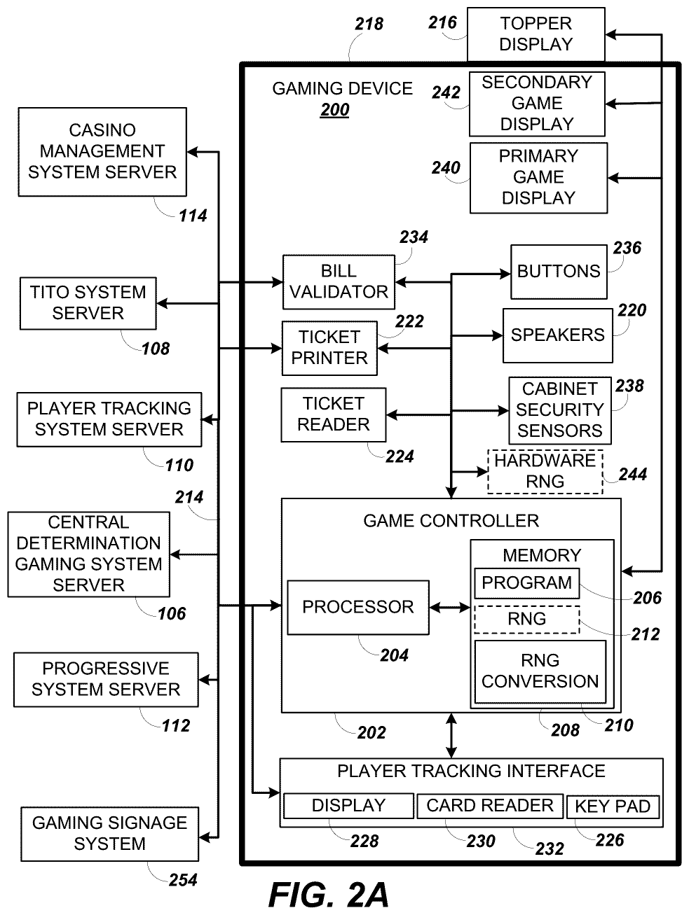

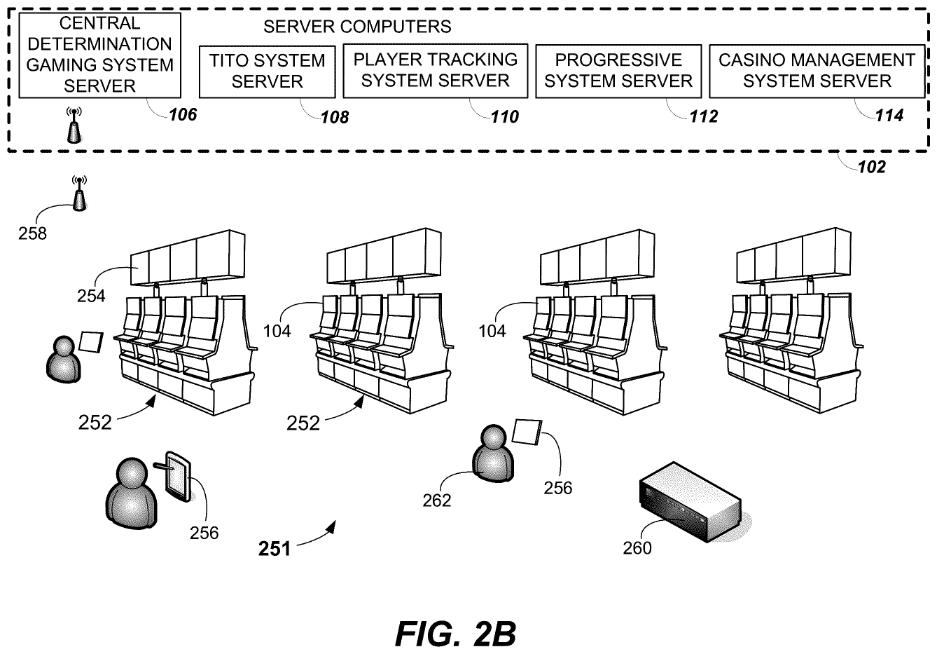

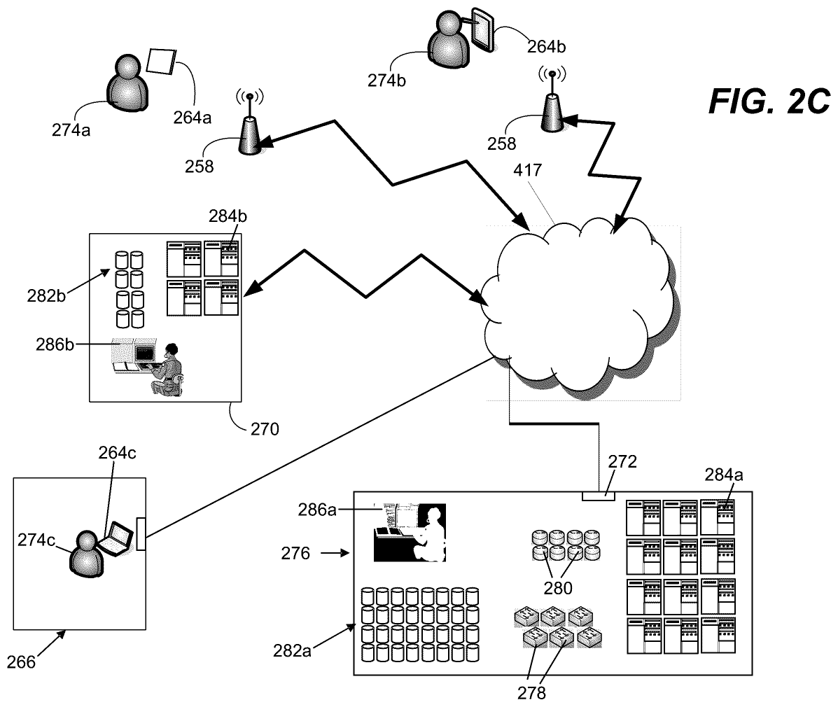

Many or all the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286b. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

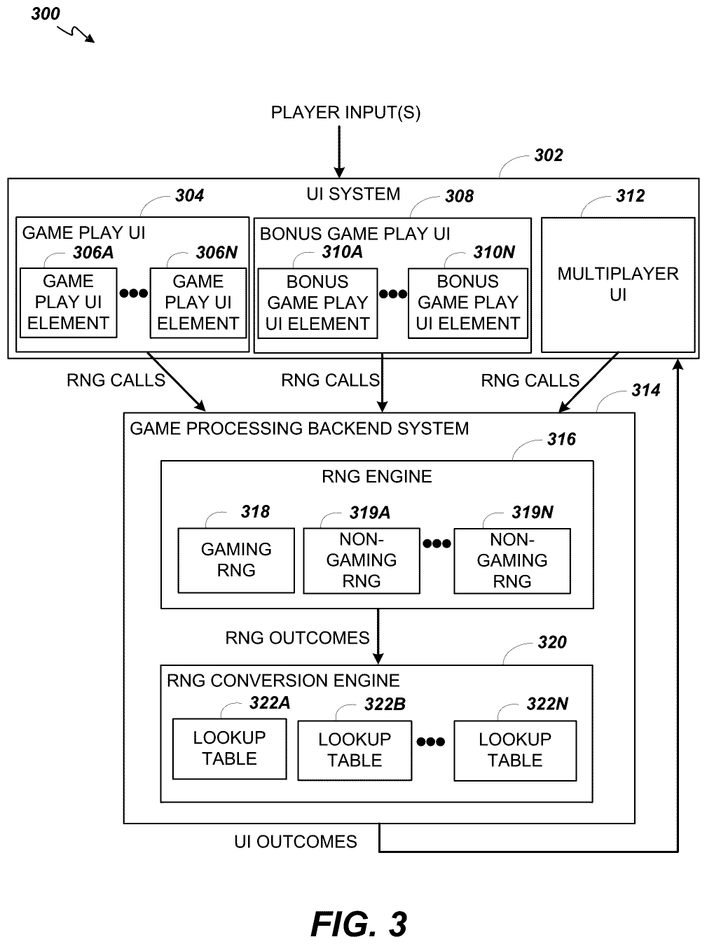

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

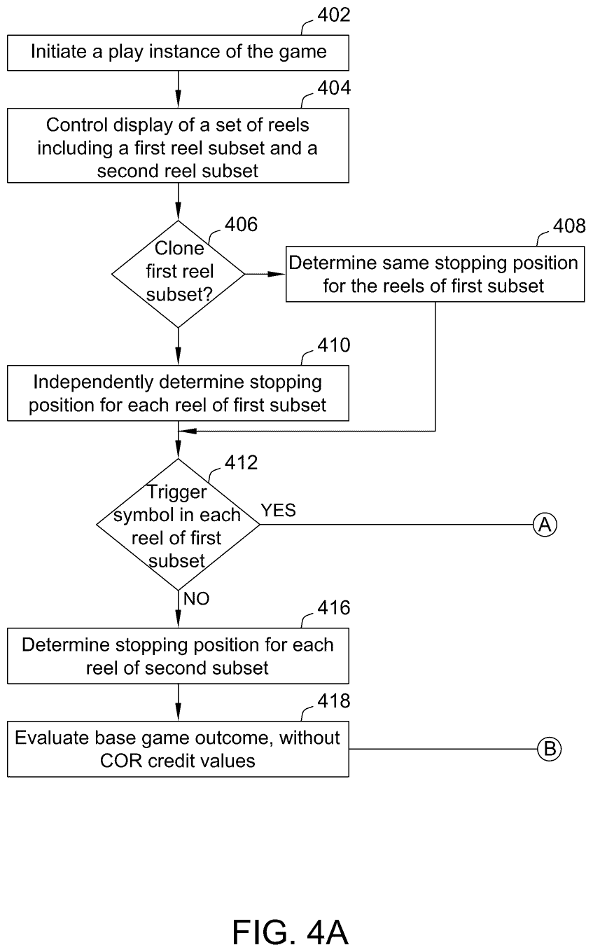

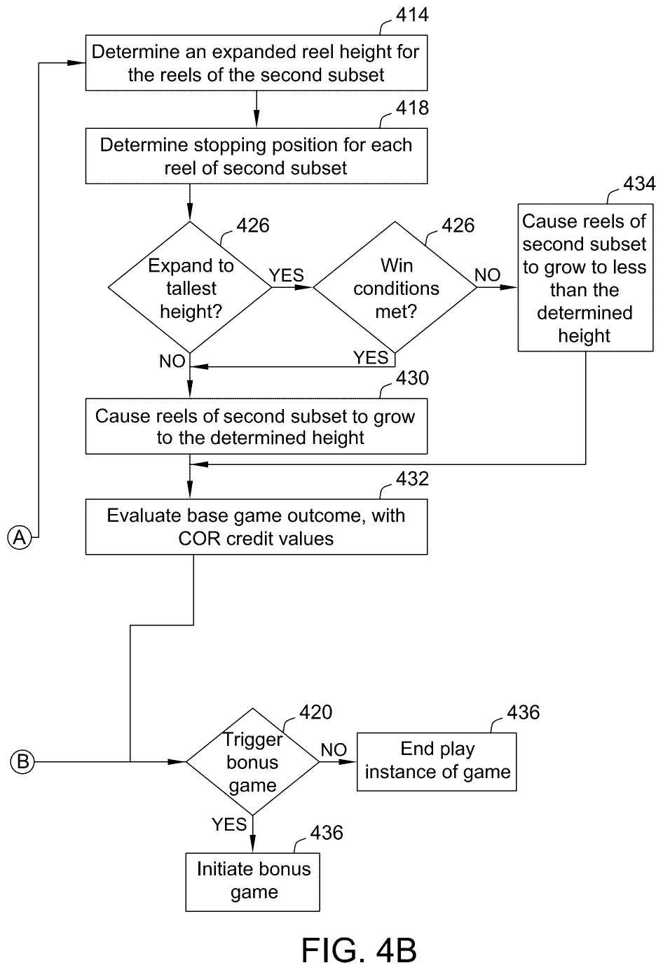

FIGS. 4A-4B are a flow chart of an exemplary process 400 for executing electronic game play for display to a user. The process 400 may be implemented in a server (e.g., server 102) and/or a gaming device (e.g., gaming devices 104A-104X in FIG. 1, and/or gaming device 200 and/or mobile gaming device 256 in FIG. 2). For example, in an electronic gaming device, a game controller (e.g., game controller 202) includes one or more processors 204 operatively coupled to memory 208. The memory 208 can store one or more game programs 206 that provide program instructions and/or data for carrying out various implementations (e.g., game mechanics) that, when executed by the processor 204, cause the processor 204 to perform certain operations to perform the process 400.

At operation 402, the processor 204 initiates a play instance of a game. In some embodiments, prior to initiating the play instance, the processor 204 first receives a selection of a bet option from the player, for example, via buttons 236. In an example, there are a plurality of bet options where bet1<bet2<bet3 etc.

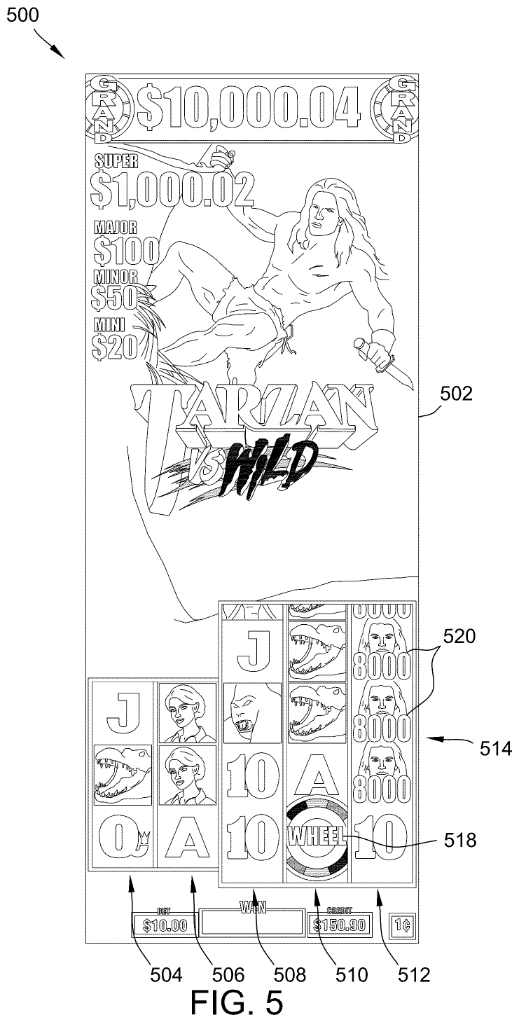

At operation 404, the processor 204 controls a display, such as display 240, to display plurality of reels in a viewable matrix 514 of symbol positions for the game instance initiated at operation 402. Referring to FIG. 5, which shows a screen display 500 of the game play presented on a user interface (UI) 502 (e.g., a UI of the UI system 302, such as game play UI 304), in an example, there are five reels 504-512 respectively displayed in one of five columns of the matrix 514 of symbol positions. The reels 504-512 having varying heights, that is, a number of rows of the matrix 514 changes across the columns in which the reels 504-512 are displayed. The reels 504 and 506 are displayed in columns of the matrix that each include three rows, that is, there are three symbol positions for each reel 504 and 506. The reels 504 and 506 do not change in height during game play, that is, the columns of the matrix 514 in which the reels 504 and 506 are displayed are fixed at three rows in height. The reels 504 and 506 may also be referred to herein as a first set of reels 504, 506 or a first subset of reels 504, 506. The reels 508-512 are displayed in columns of the matrix 514 which, at the beginning of the game instance initiated at operation 402, each include four rows. That is, at the beginning of the game instance, there are four symbol positions in the matrix 514 for each reel 508-512. Unlike the first set of reels 504, 506, the reels 508-512 may change in height during game play, described in more detail below. The reels 508-512 may also be referred to herein as a second set of reels 508-512 or a second subset of reels 508-512.

It is understood that the matrix 514 may have other configurations and different numbers of symbol positions (i.e., different numbers of columns and respective rows) than shown in the example implementation of FIG. 5. In some implementations, the first set of reels 504, 506 may include more than two reels, depending on the number of columns in the matrix 514 for the first set of reels. Additionally, or alternatively, the second set of reels 508-512 may include more or fewer than three reels, depending on the number of columns in the matrix 514 for the second set of reels. The columns of the matrix 514 corresponding to the fixed-height first set of reels 504, 506 may have more or fewer than three rows (symbol positions) each. At the beginning of the game instance, the columns of the matrix 514 corresponding to the variable-height second set of reels 508-512 may have more or fewer than four rows (symbol positions) each.

In the example implementation, the game UI 502 is presented on a display, such as display 240 of an electronic gaming device 200 (FIG. 2A). In other embodiments, the display may be provided on a mobile or remote device, such as a smart phone, tablet, computer, or any other suitable remote device. In some such embodiments, one or more of the steps of process 400 may be performed by one or more processors, such as a processor of the remote device and a processor of a central server in communication with the remote device.

The UI 502 may also display additional graphics associated with the electronic game. For example, the UI 502 may include, in addition to the matrix 514, jackpot meters, including a grand jackpot meter, a major jackpot meter, a minor jackpot meter, and a mini jackpot meter. In some examples, there may be different jackpot meters and/or more or fewer than three jackpot meters provided by the UI 502. The UI 502 may, in some implementations, also provide a metamorphical graphical element, or metamorphic, that transforms (e.g., by animation provided on the UI 502) to visually indicate various features of the electronic game that may be triggered during base game play. Any types of metamorphics, objects, symbols, or other graphic elements may be used and provided on the UI 502 to visually inform progress of the electronic game or features of game play. The UI 502 may also provide a credit meter indicating a credit balance of a player of the electronic game, a bet meter, and one or more input buttons (e.g., a SPIN button) that may be selected to initiate a play of the electronic game or provide some other game play input. The elements provided by the UI 502 are by way of example only, and may be displayed on alternative displays such as those described elsewhere herein. The UI 502 may also provide additional graphics other than those illustrated and described.

As described herein, during play of the game instance initiated at 402, symbols may be selected (e.g., such as from the reel strips associated with the reels 504-512) and displayed in the symbol positions within the matrix 514. Although not central to an understanding of the present disclosure, each reel strip associated with one of the reels 504-512 may include a plurality of symbols arranged in a vertical column. In the example embodiment, the reel game uses virtual reel strips for the reels 504-512. The reel strips may include various basic symbols (e.g., “A”, “K”, “Q”, “J”, “10”, “9”, picture symbols), as well as feature symbols. The feature symbols may, in some examples, include bonus game symbols 518 and/or cash on reel (COR) symbols 520. The bonus game symbols 518 may trigger a bonus game when a triggering number appear in the matrix 514, as described further below. The COR symbols 520 correspond to credit values that may be awarded for each COR symbol appearing in the matrix 514, provided one or more conditions are met as described further below. A number of symbols of each reel 504-512, corresponding to the number of rows in the respective column, is displayed within the reel matrix 514 during play of the game instance.

To display symbols from a reel within the matrix 514, the processor 204 may simulate rotation or spinning of one or more of the reels 504-512 within a respective column. When a respective reel is simulated to halt or stop within an associated column, one or more symbols may be displayed from the reel strip in the symbol positions of the column. The symbols displayed after spinning and stopping each reel in a respective column or symbol position of the reel matrix 514 may be referred to herein as a “reel outcome” or a “base reel game outcome” or a “base game outcome.” More broadly, an “outcome” of a reel game refers to the symbols displayed in a reel matrix after reels are spun and stopped. Thus, a rotation and stopping of the reels 504-512 (also referred to herein as a “spin and stop sequence”) may be simulated by processor 204 within the columns of the matrix 514 to cause a reel outcome, including a plurality of symbols, to be displayed from the associated reel strips within the matrix. Each play of the reel game may include one or more reel game outcomes, that is, each play of the reel game may include a single spin and stop sequence of the reels 504-512 or multiple spin and stop sequences.

Referring back to FIGS. 4A-4B, at operation 406, the processor 204 determines whether the reels 504, 506 are “cloned,” that is, whether the symbols displayed within the matrix 514 on the reels 504, 506 are the same. Specifically, in response to initiating the game instance at 402, the processor 204 determines at 406 whether the stopping positions for each reel 504 and 506 are the same or independently determined. The determination at 406 may be made based on an RNG outcome (e.g., generated using the RNG 212 of FIG. 2A).

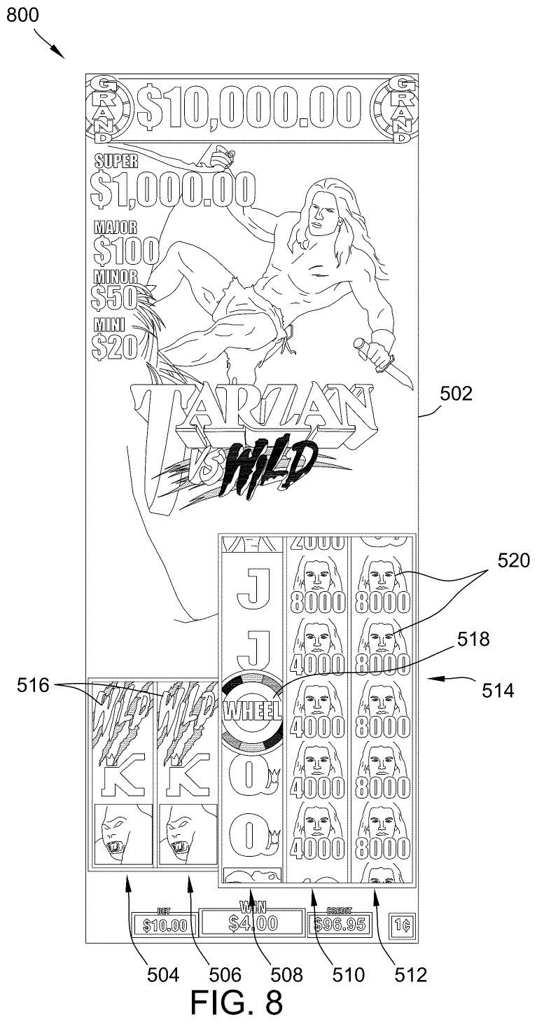

In response to determining at 406 that the reels 504, 506 are cloned for the game instance, the processor 204, at operation 408, selects symbols from a reel strip for display in the corresponding columns for each of the reels 504, 506. For example, the processor 204 may determine the same stopping position of a reel strip for each reel 504, 506, based on an RNG outcome. Based on the stopping position, processor 204 may select symbols from a reel strip and/or one or more lookup tables and cause those symbols to be displayed on each reel 504, 506 on the UI 502. The screen display 800 of FIG. 8 depicts an example outcome in which the reels 504, 506 are cloned, and the same symbols are displayed in the same symbol positions on each reel 504, 506.

In response to determining at 406 that the reels 504, 506 are not cloned for the game instance, the processor 204, at operation 410, independently selects symbols from one or more reel strips for display in the corresponding columns of the reels 504, 506. For example, the processor 204 may determine at 410 a stopping position of a reel strip for the reel 504, based on a RNG outcome, and a stopping position of a reel strip for the reel 506, based on a different (or independently generated) RNG outcome. Based on the determined stopping positions at 410, processor 204 may select symbols from one or more reel strips and/or one or more lookup tables and cause those symbols to be respectively displayed on the reels 504, 506 on the UI 502. Alternatively, in some embodiments, the processor 204 at 410 may select symbols for display on the reels 504 and 506 from different reel strips, but based on a single RNG outcome. In some implementations, the processor 204 selects symbols for display on the reels 504, 506 from different reel strips based on different RNG outcomes at operation 410. The screen display 500 of FIG. 5 depicts an example outcome in which the reels 504, 506 are not cloned, and different symbols are displayed on each reel 504, 506.

Following operation 408 or operation 410, symbols are displayed on the reels 504 and 506 within the matrix 514. Meanwhile, the processor 204 may control the UI 502 to continue spinning each of the second set of reels 508-512. At operation 412, the processor 204 determines whether the symbols displayed on the reels 504 and 506 satisfy a trigger condition for expanding the heights of the second set of reels 508-512. The second set of reels 508-512 may remain spinning after the symbols are displayed on the reels 504 and 506 to visually inform the player that the outcome on the reels 504 and 506 influences the remainder of the game instance and, in particular, whether the expanding height feature of the reels 508-512 is triggered.

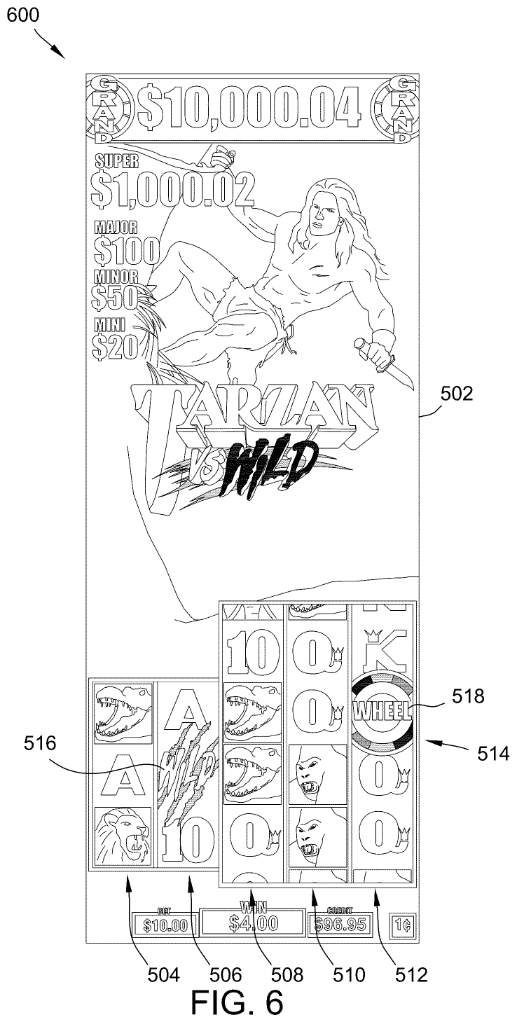

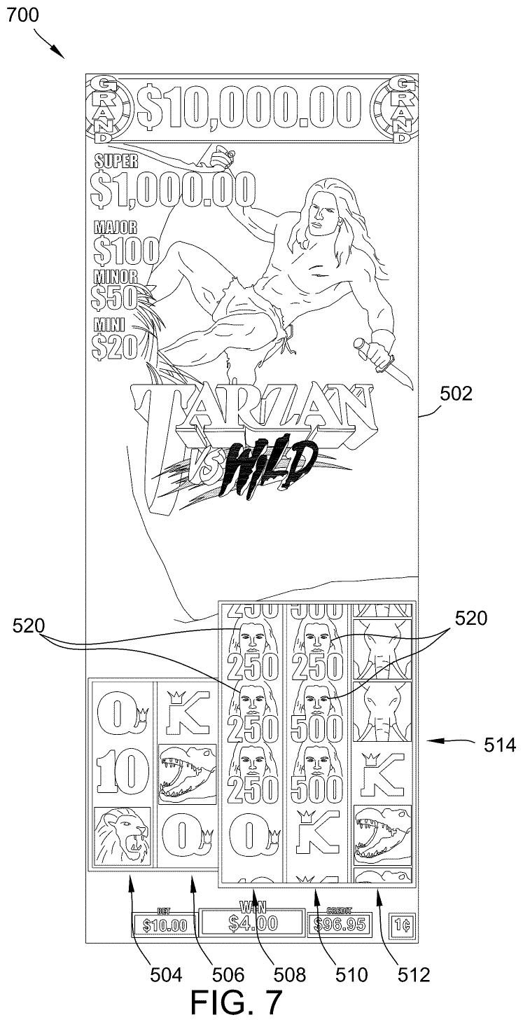

In the example implementation, the expanding reel height trigger condition is a WILD symbol 516 appearing on each of the first set of reels 504, 506. If a WILD symbol 516 appears on each reel 504, 506, the play of the game instance proceeds with the processor controlling the UI 502 to cause the reels 508-512 to expand or grow in height to a height determined at operation 414, which will be described in more detail below. In response to a WILD symbol 516 not appearing on each reel 504, 506, the play of the game instance proceeds at operation 416, at which the processor 204 determines stopping positions for each of the second set reels 508-512 without expanding the height of the reels 508-512 on the UI 502. That is, the reels 508-512 remain at the same height as the height of the reels 508-512 when the game instance was initiated, which is four rows in the example implementation. The reels 508-512 remain at this height, as determined at operation 412, when, after the operation 408 or 410, no WILD symbols 516 appear in either reel 504 or 506 (as shown in FIGS. 5 and 7), or if a WILD symbol 516 appears in only one of the reels 504 or 506 (as shown in FIG. 6). The cloned reel feature determined at operation 406 may, if triggered, increase the chances of a WILD symbol 516 appearing in each of the reels 504 and 506 to trigger the expanding reel height feature.

At operation 416, the processor 204 may independently select symbols from one or more reel strips for display in the corresponding columns of the reels 508-512. For example, the processor 204 may determine at 416 a stopping position of a reel strip for the reel 508, based on a RNG outcome, a stopping position of a reel strip for the reel 510, based on a different (or independently generated) RNG outcome, and a stopping position of a reel strip for the reel 512, based on a yet another different (or independently generated) RNG outcome. Based on the determined stopping positions at 416, processor 204 may select symbols from one or more reel strips and/or one or more lookup tables and cause those symbols to be respectively displayed on the reels 508-512 on the UI 502. Alternatively, in some embodiments, the processor 204 at 416 may select symbols for display on the reels 508-512 from different reel strips, but based on a single RNG outcome. In some implementations, the processor 204 selects symbols for display on the reels 508-512 from different reel strips based on different RNG outcomes at operation 416.

Following operation 416, symbols are displayed on each of the reels 504-512 within the matrix 514, forming an outcome of a game instance that may then be evaluated. FIGS. 5-7 show screen displays 500, 600, 700 of various outcomes of the game in which the expanding reel height feature is not triggered. The expanding reel height feature is not triggered in the outcomes of FIGS. 5 and 7 since no WILD symbols 516 appear on the reels 504 and 506. The expanding reel height feature is not triggered in the outcome of FIG. 6 since a WILD symbol 516 only appears on reel 506, and not on reel 504. As a result, in the outcomes shown in FIGS. 5-7, the matrix 514 has the same 3×3×4×4×4 configuration at the initiation and in the outcome of the game instance.

With the symbols displayed within the matrix 514, the outcome may be evaluated at operation 418 for winning symbols and/or symbol combinations that provide an award or another game feature to the player. Any win conditions within the matrix 514 can be detected by the processor 204 and any win amounts can be awarded to the player (e.g., credited to the player's credit balance). The win conditions may be defined according to a “ways” approach or may be defined as pay lines or win lines. In the example implementation, the win conditions are defined according to a ways approach, in which symbols displayed at symbol display positions within one of the columns of the matrix 514 can be used to form symbol combinations (one symbol per reel in a combination) with the symbols displayed at designated symbol display positions of each of the other columns of the matrix 514. For example, in the example matrix 514 in which there are five reels 504-512, and three symbol display positions for each reel 504 and 506 and four symbol display positions for each reel 508-512, each possible path through the symbol display position(s) of the respective reels may provide a way to win. The total number of ways to win in the matrix 514 may be determined by multiplying the number of active display position(s) of each reel 504-512, where the active display position(s) for a reel are all display positions in the matrix 514. As a result, in the absence of the expanding reel height feature, there 3×3×4×4×4=576 ways to win for the matrix 514. In other implementations, win conditions may be defined as pay lines (also called win lines) across at least a portion of the reel matrix 514. In these other implementations, when a certain combination of symbols appears along a pay line, a win amount corresponding to that combination of symbols and that pay line may be awarded. Win amounts can vary according to the combination of symbols and according to the particular pay line along which the combination of symbols appears. Win amounts are typically determined according to a pay table, where the pay table comprehends the various combinations of symbols and pay lines that may occur (i.e., the win conditions). The win amount for a round of play may be a fraction of an amount wagered for that round of play for certain win conditions. For other win conditions, the win amount may be much larger than the amount wagered. Whether the win conditions are evaluated according to a ways approach or based on paylines, the expanding reel feature increases the chances to win (e.g., by increasing the number of ways to win or the possible paths to form a winning payline in the matrix 514).

As shown in FIGS. 5-7, feature symbols may be displayed on the reels 504-512 that may provide certain awards and/or unlock certain features of the game once all the reels 504-512 have spun and stopped. The WILD symbols 516 that may appear on the reels 504, 506 may be treated as “wild” symbols for the purposes of evaluating the outcome at operation 418. For example, the screen display 600 of FIG. 6 shows the wild symbol 516 appearing on the second reel 506, which is treated as a wild symbol for evaluating the outcome at operation 418. In the example implementation, bonus game symbols 518 and COR symbols 520 may also be displayed in the matrix 514. The COR symbols 520 may be displayed within the matrix 514 on any of the second set of reels 508-512. The bonus game symbols 518 may be displayed within the matrix 514 on the any of the reels 504-512.

The COR symbols 520 each display a value associated with the symbol. For example, referring to the screen display 500 of FIG. 5, a stack of three COR symbols 520 each having a value of 8000 credits are shown on the fifth reel 512. The screen display 700 of FIG. 7 shows a stack of three COR symbols 520 in each of the third reel 508 and the fourth reel 510. The COR symbols 520 of the stack on the third reel 508 each have a value of 250 credits and the COR symbols 520 of the stack on the fourth reel 510 include two 500-credit symbols and one 250-credit symbol.

The credit values associated with the COR symbols 520 may be determined based on one or more RNG outcomes and/or lookups. Each of the different COR symbols 520 appearing on the second set of reels 508-512 are dynamic, in that the value of the COR symbols are determined by the additional RNG outcome and/or lookup in a lookup table separate from the stopping position determination at operation 416 (or operation 424). The values of the COR symbols 520 for any given position on a reel strip may change between game instances based on the additional lookup.

In the example implementation, an RNG outcome is generated (e.g., by the RNG 212) and/or a lookup is performed to determine the credit value for each COR symbol 520 that appears. The RNG outcomes may be mapped to one or more pay tables stored in memory (e.g., the memory 208) to determine the credit value for each COR symbol 520. Different pay tables may be used to determine the credit values for COR symbols 520 appearing on different reels 508-512. That is, COR symbols 520 appearing on the third reel 508 may have credit values determined from one or more pay tables that are different from the pay tables used to determine the credit values for COR symbols 520 appearing on the fourth and fifth reels 510 and 512. Similarly, the COR symbols 520 appearing on the fourth reel 510 may have credit values determine from one or more pay tables that are different from the pay tables used to determine the credit values for COR symbols 520 appearing on the fifth reel 512. In the example implementation, single instances of COR symbols 520 on a reel 508-512 may also have credit values determined from pay tables that are different from the pay tables used to determine credit values for COR symbols 520 appearing in a stack of two or more COR symbols on a reel 508-512.

In the example implementation, in order to evaluate to the value of credits shown on the COR symbol 520, two conditions must be met. First, a WILD symbol 516 must appear in each of the first set of reels 504 and 506. Thus, at operation 418, the credit values of the COR symbols 520 are not evaluated/awarded because a WILD symbol 516 is not displayed on each reel of the first set of reels 504 and 506 (as determined at operation 412). The second condition, which is moot at operation 418 but will be described further below for when WILD symbols 516 appear in each of the reels 504 and 506, is at least one COR symbol 520 appearing in third reel 508 in order for the credit values of the COR symbols 520 on the fourth reel 510 to be evaluated and at least one COR symbol 520 appearing in each of the third and fourth reels 508, 510 in order for the credit values of the COR symbols 520 on the fifth reel 512 to be evaluated. With the second condition, COR symbols 520 on the fourth and fifth reels 510, 512 may have credit values determined from pay tables having larger credit values or greater weighting for hitting larger values than the pay table(s) used to determine credit values for COR symbols 520 on the third reel 508. That is, the provision of the second condition provides a control on payout volatility and facilitates implementing the larger credit values of COR symbols 520 on the fourth and fifth reels 510, 512. The COR symbols 520 on the fifth reel 512 may also have credit values determined from one or more pay tables having larger credit values or greater weighting for hitting larger values than the pay table(s) used to determine credit values for the COR symbols 520 on the fourth reel 510.

Also included in the evaluation at operation 418 is a determination by the processor 204 of the bonus game symbols 518, if any, that appear within the matrix 514 on the reels 504-512. The bonus game symbols 518 that may appear on the reels 504-512 may be treated as “blocking” symbols for the purposes of evaluating the outcome at operation 418 and determining an award. That is, any symbol position within the matrix 514 that includes a bonus game symbol 518 may be blocked or precluded from forming a winning symbol combination. For example, in the outcome showed in the screen display 500 of FIG. 5, the bottom position of the fourth reel 510 that includes a bonus game symbol 518 is precluded from forming a way to win (under a ways approach) or a winning pay line. In the outcome showed in the screen display 600 of FIG. 6, the symbol position directly below the topmost symbol position on the fifth reel 512 that includes a bonus game symbol 518 is likewise precluded from forming a way to win or a winning pay line.

As described further below, a bonus game may be triggered, determined the processor 204 at operation 420, when a minimum or triggering number of bonus game symbols 518 appear within the matrix 514. The bonus game symbols 518 may be treated as scatter symbols for the purpose of this determination, meaning that the bonus game symbols 518 may appear at any symbol position within the matrix 514 in order to trigger the bonus game, provided the triggering number of bonus game symbols is met. Any suitable number of bonus game symbols 518 may be used as the triggering number. In the example implementation, the triggering number of symbols to trigger the bonus game is three bonus game symbols 518. In each of the outcomes shown in FIGS. 5-7, the triggering number of bonus game symbols 518 is not met. Accordingly, the processor 204 determines at 420 that the bonus game is not triggered, and proceeds to end the play of the game instance at 422 and an award, if any, resulting from the outcome of the game instance is paid out to the player.

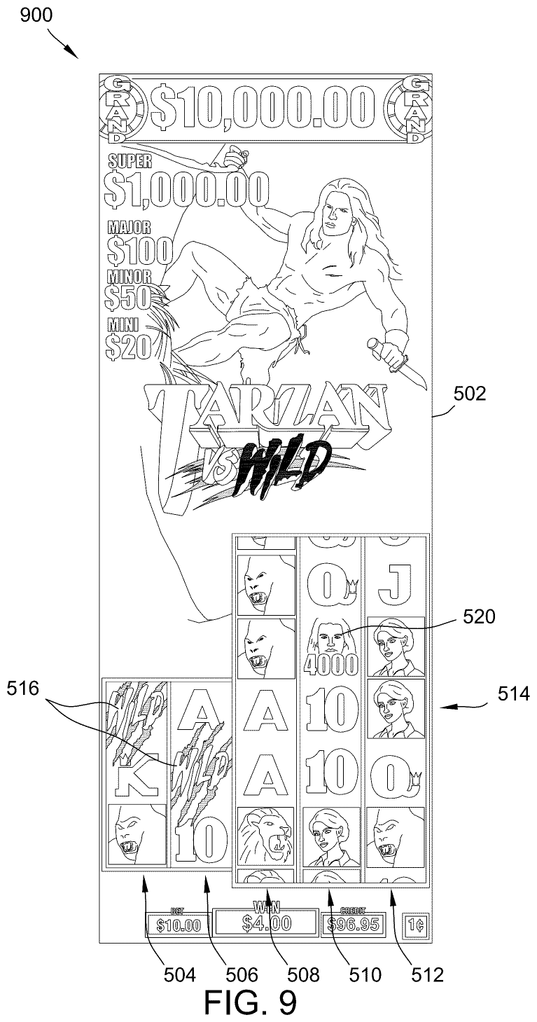

Referring back to operation 412 of the process 400 of FIGS. 4A-4B, and with additional reference to FIG. 8, the appearance of a WILD symbol 516 on each reel of the first set of reels 504, 506 triggers an expanding reel height feature of the second set of reels 508-512. In particular, in response to determining at 412 that a WILD symbol 516 appears on each reel 504, 506, the processor controls the UI 502 to cause the reels 508-512 to expand or grow in height. The WILD symbols 516 may appear in any symbol position on the reels 504 and 506 in order to trigger the expanding reel height feature. For example, the WILD symbols 516 may appear in the same rows on each reel 504 and 506, as shown in FIG. 8, but may also appear in different rows as shown in FIG. 9.

At operation 414, the processor 204 determines an expanded reel height for the reels 508-512. The expanded reel height is determined based on a lookup operation or an RNG outcome (e.g., generated by the RNG 212). In the example implementation, a lookup is performed at operation 414 to determine a reel height selected from five rows (five symbol positions), six rows (six symbol positions), and eight rows (eight symbol positions) to which the reels 508-512 will grow. The lookup may ensure that at least some height expansion of the reels 508-512 will occur. In other examples, no expansion in height may be an option of the lookup operation performed at 414. The same expanded height is used for the reels 508-512, but in other implementations the reels 508-512 may grow to different heights which may be determined based on one or multiple lookups (e.g., a different lookup for the height of each reel 508-512). Based on the lookup/RNG outcome at operation 414, the processor 204 may control the UI 502 to cause the reels to expand or grow to the determined height at operation 430. Prior to the operation 430, several back-end operations may be performed by the processor 204 which will now be described.

At operation 424, after the expanded reel height is determined at 414, the processor 204 determines stopping positions for each of the second set of reels 508-512, as described above for 416. The stopping positions are determined at 424 before the processor controls the UI 502 to cause the reels 508-512 to grow in height. This may enable the processor 204 to evaluate the outcome of the game instance at various heights of the reels 508-512 and implement any additional checks before the reels 508-512 grow to the height determined at 414. The outcome evaluation is described in more detail with respect to operation 432, however, the numerical ordering/sequencing of the process 400 is not intended to limit the evaluation to being performed after operations 426-430. More broadly, the order of the actions described herein for the process 400 are not limited to any particular order unless expressly stated otherwise or the context clearly indicates otherwise.

In the example implementation, the determination at 424 enables the processor 204 to implement a check prior to expanding the reels 508-512 to the tallest possible height (eight rows in this example). In particular, the processor 204 at operation 426 determines whether the expanded reel height determined at 414 is the tallest possible height and, if so, the processor 204 determines at 428 whether one or more win conditions are satisfied prior to controlling the UI 502 to cause the reels 508-512 to grow to the determined height. If the expanded reel height determined at 414 is not the tallest possible height (e.g., is five rows or six rows), then the process 400 continues to operation 430, and the processor 204 controls the UI 502 to cause the reels to expand or grow to the determined height at operation 430. The screen display 800 of FIG. 8 and the screen display 900 of FIG. 9 show the reels 508-512 expanded to a height of five rows each.

The one or more win conditions applied at operation 428 may ensure that the outcome of the game instance is of sufficient value to justify expanding the reels 508-512 to the tallest possible height (eight rows in this example). This may enable reserving the tallest expanded reel height feature for relatively large payouts or exciting wins. In the example implementation, to enable the reels 508-512 to grow to the tallest height, the processor 204 at operation 428 must determine that at least one of the following win conditions is satisfied: i) an outcome of the game instance having an award value of at least five times the originally placed bet at 402, and ii) at least three bonus game symbols 518 appearing in the matrix 514. The win conditions are assessed at operation 428 based on the reels 508-512 at their expanded height (i.e., evaluated with the additional symbol positions of the expanded reels). It is understood that more, fewer, or other win conditions may be applied at operation 428 than those in the example implementation.

If the processor 204 determines at 428 that the outcome of the game instance will result both i) in an award value of less than five times the original bet and ii) fewer than three bonus game symbols 518 appearing in the matrix 514, the processor 204 at operation 434 applies the check and controls the UI 502 to cause the reels 508-512 to grow to a height that is shorter than the determined height. For example, at operation 434, the processor 204 may apply the check and cause the reels 508-512 to grow to the second tallest height (e.g., six rows) rather than the tallest height that was determined at 414. The processor 204 may control the reels 508-512 at 434 to grow to any suitable height. In some implementations, the check described above may be applied, with any suitable win conditions, to control growth of the reels 508-512 for any height determined at 414.

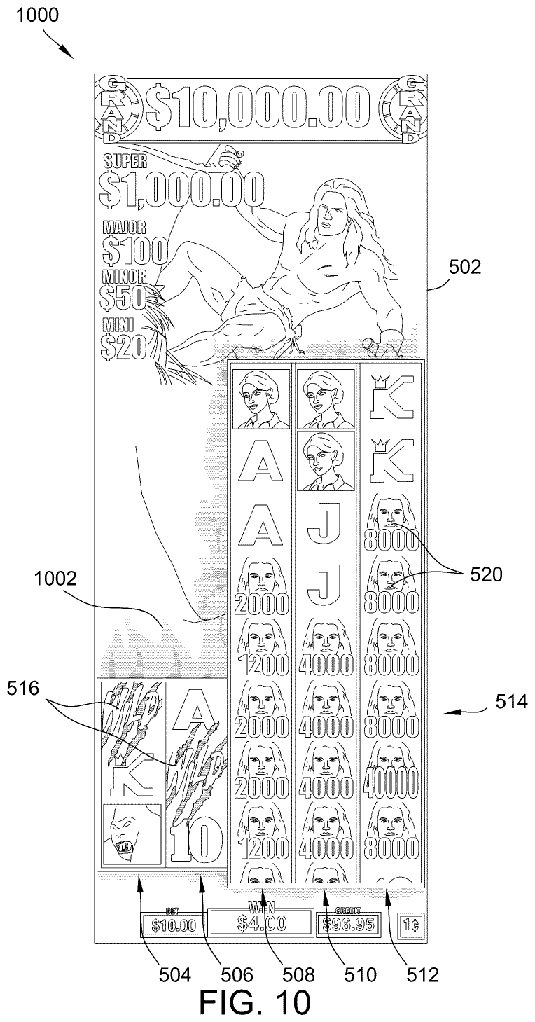

If, in response to determining at 414 that the expanded height is eight rows (or the tallest possible height) for the reels 508-512, the processor 204 determines at 428 that the outcome of the game instance will result either i) in an award value of at least five times the original bet or ii) in at least three bonus game symbols 518 appearing in the matrix 514, the process 400 proceeds to operation 430, and the processor 204 controls the UI 502 to cause the reels to expand or grow to the determined height at operation 430. The screen display 1000 of FIG. 10 shows the reels 508-512 expanded to the tallest possible height (eight rows or symbol positions each).

After causing the reels 508-512 to grow to the height determined at 414, or to the checked/controlled height at 434, the processor 204 controls the UI 502 to spin and stop the reels 508-512 at the expanded height and land at the stopping positions determined at 424. During the spin and stop sequence of the reels 508-512, an animation effect 1002 (FIG. 10) may be provided on the UI 502 to visually inform the player of the expanded reel feature. In the example implementation, the animation effect is a graphic of flames surrounding the expanded reels 508-512.

Once the reels 508-512 have spun and stopped, and symbols are displayed in each symbol position within the matrix 514, the outcome may be evaluated at operation 432 as described above for operation 418. A difference between operation 432 and operation 418 is that, in the former operation, a greater number of symbol positions are included in the matrix 514, which increases the probability that some defined win condition will be satisfied. In the example implementation, under a ways approach, there are a greater number of ways to win in the matrix 514 because the taller reels 508-512 increase the number of active display position(s) within the matrix 514. For example, referring to the screen display 1000 of FIG. 10, where the reels 508-512 are expanded to the tallest height of 8 reels, there are 3×3×8×8×8-4,608 ways to win, a significant increase from the 3×3×4×4×4-576 ways to win for the matrix 514 where the reels 508-512 are not expanded. In implementations where win conditions are defined as pay lines across at least a portion of the reel matrix 514, the greater number of symbol positions on reels 508-512 increase the number of pay lines and the chance that a certain combination of symbols will appear along a pay line.

Another difference between the evaluation at operation 432 and the evaluation at operation 418 is that, in the former operation, the first condition for evaluating/paying out the credit values of the COR symbols 520 displayed on the reels 508-512 has been met. In particular, in order for the processor 204 to evaluate the game outcome at operation 432, a WILD symbol 516 must have been displayed on each reel of the first set of reels 504, 506. This is a first prerequisite for paying out the credit values of the COR symbols 520 on the reels 508-512. Thus, at operation 432, the processor 204 determines whether any COR symbols 520 have appeared on the reels 508-512 and, if so, whether the second condition or prerequisite has been met in order for credit values of those COR symbols 520 to be included in the award of the outcome. The second prerequisite, as described above, is a left-to-right arrangement of COR symbols 520, with at least one COR symbol 520 appearing in third reel 508 in order for the credit values of the COR symbols 520 on the fourth reel 510 to be evaluated and at least one COR symbol 520 appearing in each of the third and fourth reels 508, 510 in order for the credit values of the COR symbols 520 on the fifth reel 512 to be evaluated.

As described above, each of the different COR symbols 520 appearing on the second set of reels 508-512 are dynamic, in that the value of the COR symbols are determined by the additional RNG outcome and/or lookup in a lookup table separate from the stopping position determination at operation 424. It is understood that the value of the dynamic COR symbols 520 may be determined in conjunction with determining the stopping positions of the reels 508-512 at operation 424, and the determination for whether each prerequisite for paying out the COR credit values may be made at this stage as well, to enable the processor 204 to perform the win condition check at operation 428 as described above.

Thus, at operation 424, the processor 204 may determine whether COR symbols 520 are included on any of the reels 508-512 and, in response, performs a lookup (e.g., based on a generated RNG outcome) to determine the credit value for each COR symbol 520. For example, the processor 204 may map RNG outcomes to one or more pay tables stored in memory (e.g., the memory 208) to determine the credit value for each COR symbol 520. As described above, different pay tables may be used to determine the credit values for COR symbols 520 appearing on different reels 508-512.

Because the COR symbols 520 appearing on the third reel 508 are a prerequisite for paying out the COR credit values of any COR symbols 520 within the matrix 514, these third reel COR symbols may have credit values determined from one or more pay tables that are different from the pay tables used to determine the credit values for COR symbols 520 appearing on the fourth and fifth reels 510 and 512. Similarly, the COR symbols 520 appearing on the fourth reel 510 may have credit values determine from one or more pay tables that are different from the pay tables used to determine the credit values for COR symbols 520 appearing on the fifth reel 512.

In this way, the game may advantageously be designed such that the COR symbols 520 for the third reel 508 are relatively low credit values, the COR symbols 520 the fourth reel 510 are relatively medium level credit values, and the COR symbols 520 for the fifth reel 512 are relatively high level credit values. For example, the range of credit values for the third reel COR symbols can be in the range of 150-250, for the fourth reel COR symbols the range of credit values can be 250-1000, and for the fifth reel COR symbols the range of credit values can be in the range of 1000-2500. Additionally, for the fourth and fifth reel COR symbols the game may be designed (e.g., based on the weighted lookup tables used to determine the stopping positions of the reels 510 and 512) such that there is a higher probability of landing the respective relatively medium and high COR symbols 520 on the fourth and fifth reels 510, 512 and a relatively lower probability of landing the low credit value COR symbols 520 on the third reels 508. This is facilitated by using the landing of a COR symbol on the third reel 508 as a requirement to pay out credit values of COR symbols on the fourth and fifth reels 510 and 512. In other words, the game can land medium and high value COR symbols 520 on the fourth and fifth reels 510 and 512, respectively, more frequently, without resulting in payable win to the player because a COR symbol 520 must land on the third reel 508 for the COR symbols on the fourth and fifth reels to pay out. Accordingly, controlling COR symbols which land on the third reel 508 to land with a reduced frequency (higher probability) reduce overall wins across the fourth and fifth reels 510 and 512.

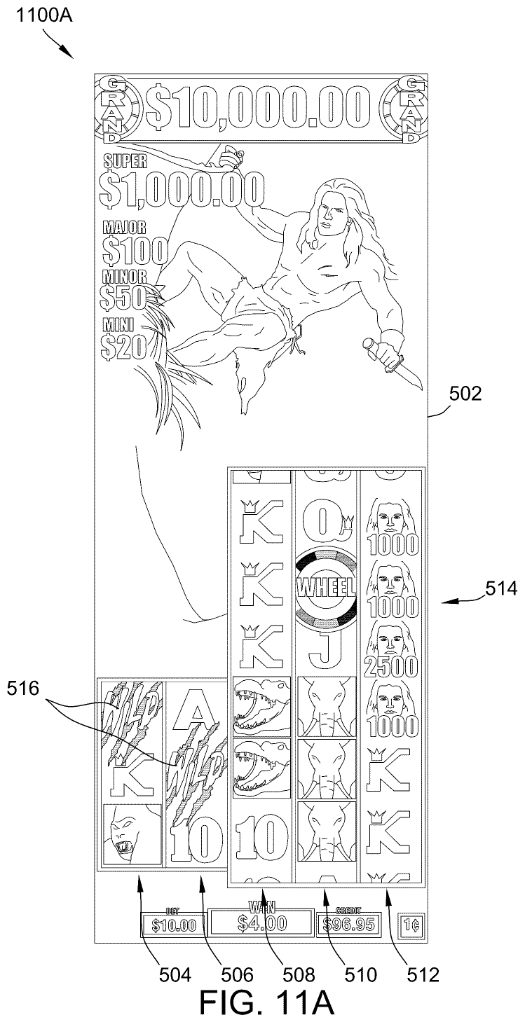

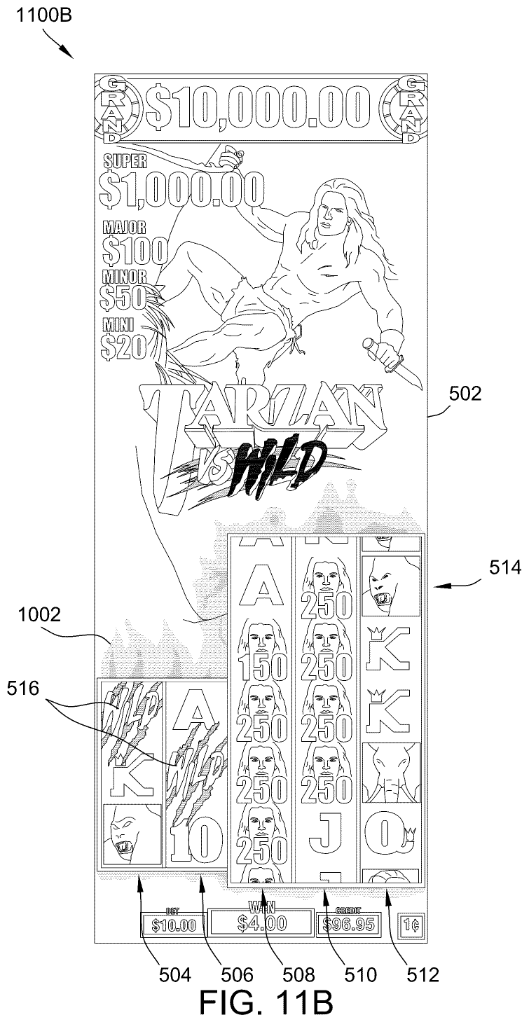

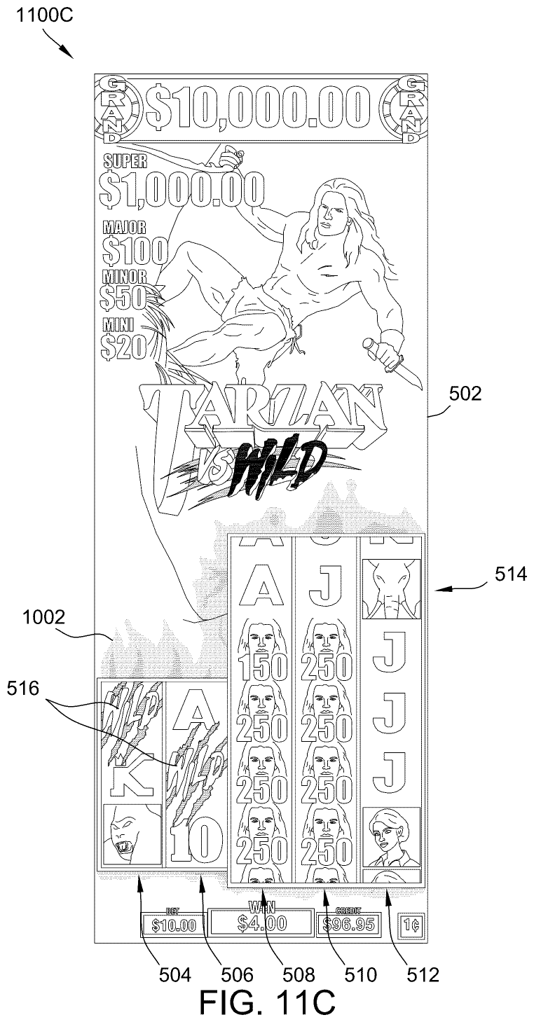

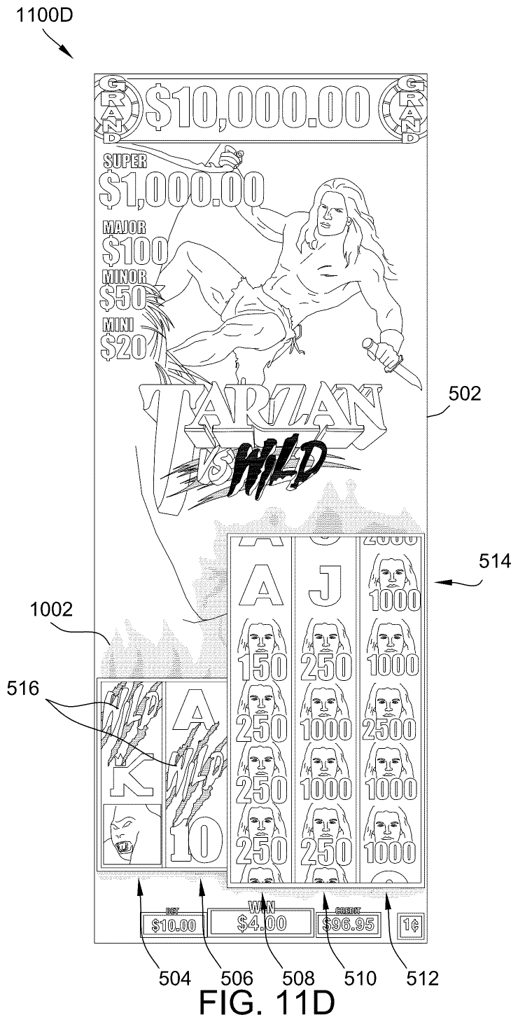

FIGS. 11A-11D depict a spin and stop sequence of the reels 508-512 expanded to a height of five rows. As shown in sequence of FIGS. 11A-11D, the first set of reels 504, 506 stops first (FIG. 11A), followed by the third reel 508 (FIG. 11B), the fourth reel 510 (FIG. 11C), and finally the fifth reel 512 (FIG. 11D). FIG. 11A is a screen display 1100A showing a transition to the expanded reels 508-512, and FIG. 11B shows the animation effect 1002 surrounding the spinning expanded reels 508-512 after the transition in FIG. 11A. The animation effect 1002 persists throughout the spin and stop sequence. At the stage of the sequence depicted in FIG. 11A, the first set of reels 504, 506 has already spun and stopped, and the WILD symbols 516 appearing in each of the first set of reels triggered the expansion of the second set of reels 508-512. FIG. 11B is a screen display 1100B showing the third reel 508 of the expanded reels 508-512 stopped at its stopping position determined at 424, while the remaining reels of the expanded second set continue to spin. FIG. 11C is a screen display 1100C showing the third and fourth reels 508 and 510 stopped at their respective stopping positions determined at 424, while the remaining reel 512 of the expanded second set continues to spin. FIG. 11D is a screen display 1100D showing each of the expanded reels 508-512 stopped at their respective stopping positions determined at 424.

Still referring to FIG. 11D, the outcome shown in the screen display 1100D represents a situation where both prerequisites for paying out COR symbols 520 appearing on each reel 508-512 are satisfied. In particular, WILD symbols 516 appear on each reel of the first set of reels 504, 506, satisfying the first prerequisite for paying out the COR symbols 520, as well as triggering the expanding height feature of the reels 508-512. It is understood from the description herein that the two WILD symbols 516 appearing on the first and second reels 504 and 506 does not guarantee that the player of the game has won anything. The WILD symbols 516 landing on the first and second reels 504 and 506 prompts the processor 204 to expand the reels 508-512, and provide the opportunity for the credit values of the COR symbols 520 appearing on the reels 508-512 to be paid out, but the reels 504-512 themselves still must satisfy the defined win conditions for the game, and/or COR symbols 520 must still appear on the reels 508-512 in the prescribed arrangement for pay out, which are controlled by independently generated RNG outcomes as described herein. In the outcome of FIG. 11D, the credit values of all the COR symbols 520 that appear on the reels 508-512 are paid out because of the WILD symbols 516 on the first set of reels 504, 506 and the left-to-right arrangement of the COR symbols 520, which populate symbol positions in each of the second set of reels 508-512.

Referring back to FIGS. 4A-4B, after the outcome shown in FIG. 11D is displayed, the award associated with the outcome, including the credit values of the COR symbols 520, is paid out to the player. The processor 204 may also determine, at operation 420, whether a bonus game is triggered as described above. Here again, it is understood that this operation/determination may take place earlier in the process sequence, and the order of actions of the process 400 is not limited to the sequence described. For example, the processor 204 may determine whether the bonus game is triggered in conjunction with the operation 424, to enable the processor 204 to perform the check at operation 428 as described above. In the outcome of FIG. 11D, the bonus game is not triggered because the triggering number of bonus game symbols 518 are not displayed. Accordingly, the process 400 continues to 422 and the game instance ends.

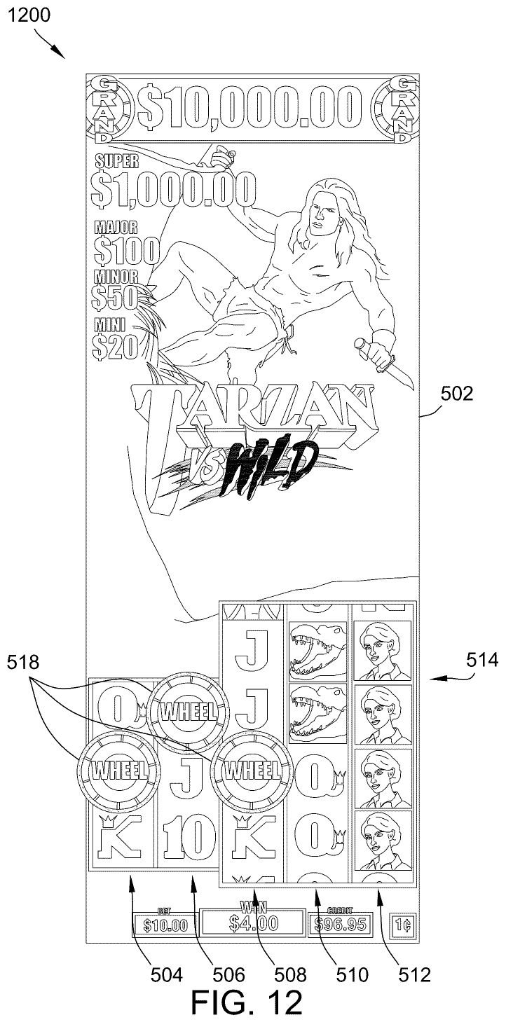

FIG. 12 depicts a screen display 1200 of an outcome of a game instance in which the triggering number (i.e., three in the example implementation) of bonus game symbols 518 are displayed in the matrix 514. Two things regarding the conditions to trigger the bonus game are apparent from the screen display 1200. First, WILD symbols 516 do not have to land on the first set of reels 504, 506 in order for the bonus games symbols 518 to trigger the bonus game, provided the triggering number is displayed. Second, the bonus game symbols 518 are scatters, and can appear in any symbol position on any reel 504-512 to trigger the bonus game, provided the triggering number is displayed.

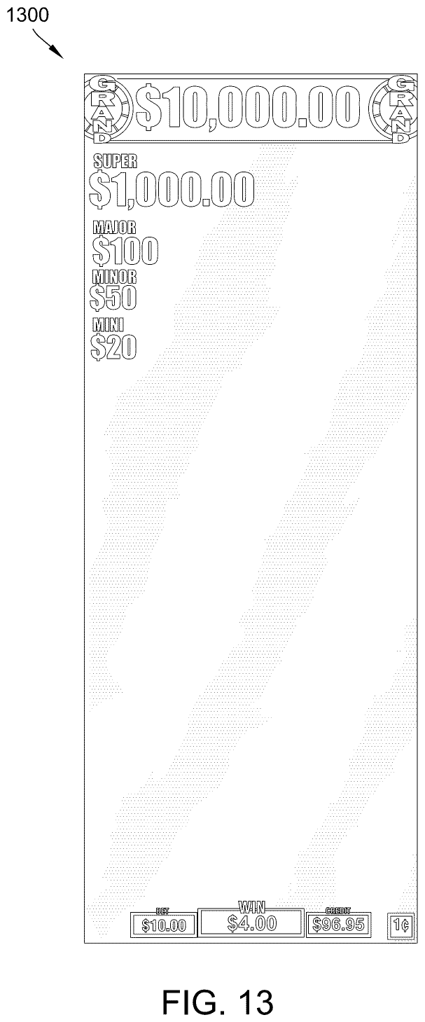

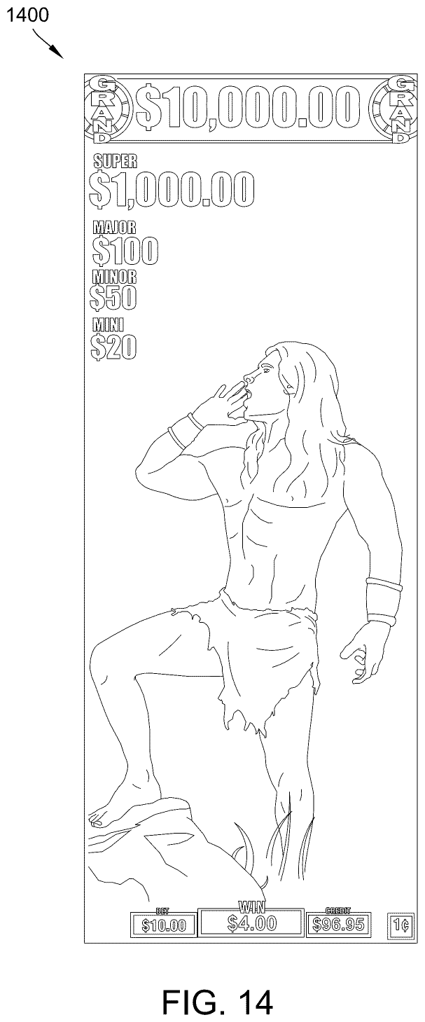

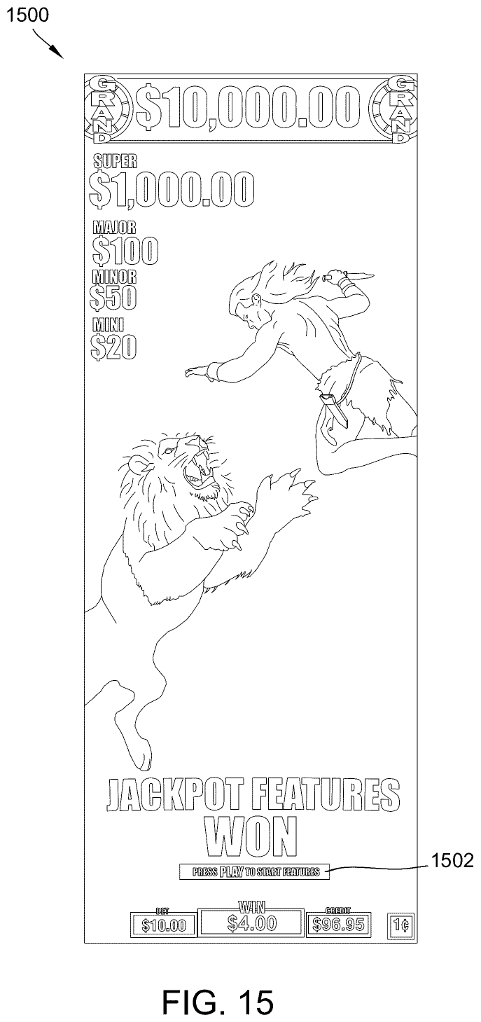

Upon landing the triggering number of the bonus game symbols 518, the processor 204 determines at operation 420 that the bonus game is triggered and proceeds to initiate the bonus game at 436. At this stage, the processor 204 may control the UI 502 to display to a transitional screen before entering the bonus feature game on a bonus UI (e.g., bonus game play UI 308). Screen displays 1300, 1400, and 1500 of these transitional screens are shown in FIGS. 13-15, respectively. The sequence of the screen displays 1300, 1400, 1500 may launch quickly in series before providing the player with a “Play” button 1502 (FIG. 15) to enter the bonus game.

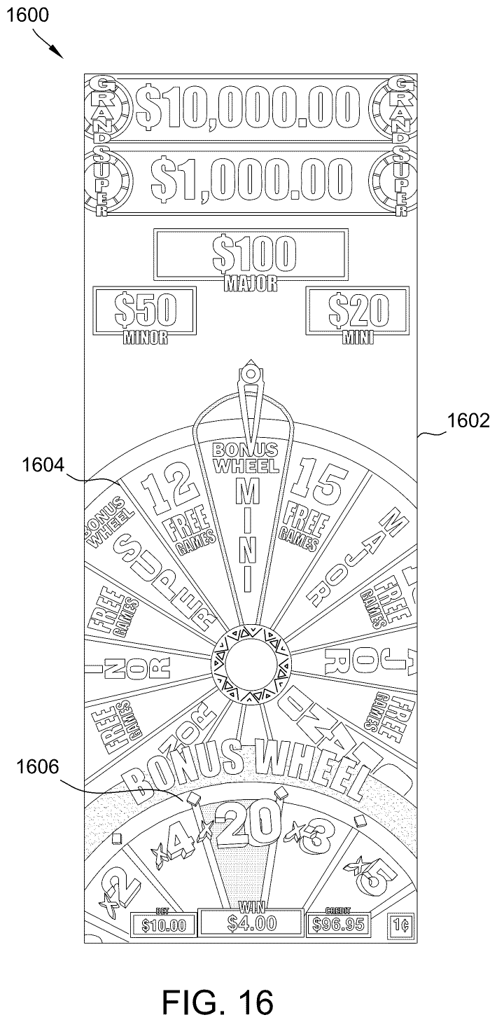

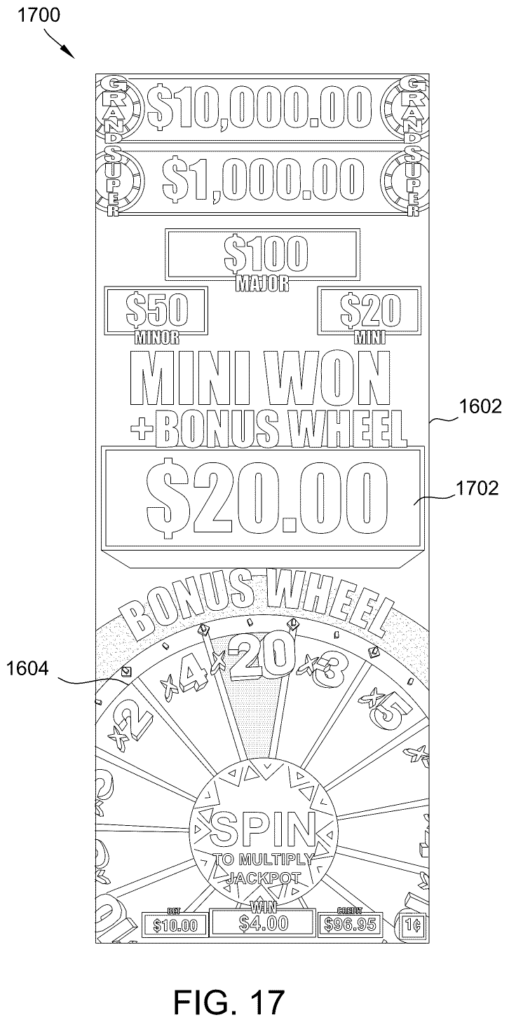

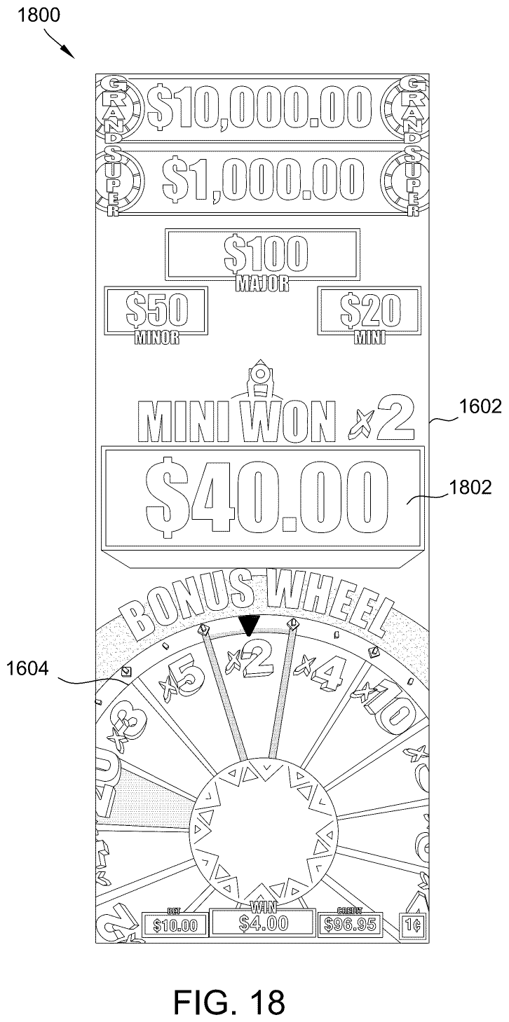

Once initiated, the bonus game offers the player a chance to play for A) Jackpots and B) Free games. The UI 1602 presenting the bonus feature game is shown in the screen display 1600 of FIG. 16. As shown, the UI 1602 displays a main (or top) wheel 1604 and a multiplier (or bottom) wheel 1606. The main wheel 1604 only contains “free spins” and “jackpots”. If the main wheel 1604 lands on a jackpot (mini, minor, major, super, grand, etc.), the game prompts the player to spin the multiplier wheel 1606 to determine a multiplier value by which the jackpot is increased. To illustrate, FIG. 17 depicts an outcome in which the main wheel 1604 lands on a bonus wheel mini jackpot, prompting the UI 1602 to display a prize window 1702 of the initial prize amount ($20.00 in this example). Subsequently, the multiplier wheel 1606 is spun, and the initial prize amount displayed in the prize window 1702 is increased by whichever multiplier value the multiplier wheel lands on. In the example screen display 1800 of FIG. 18, the multiplier wheel 1606 lands on a 2× multiplier, prompting a multiplied prize window 1802 to be displayed on the UI 1602 with the prize displayed in the window 1702 increased by 2× (amounting to $40.00 in this example).

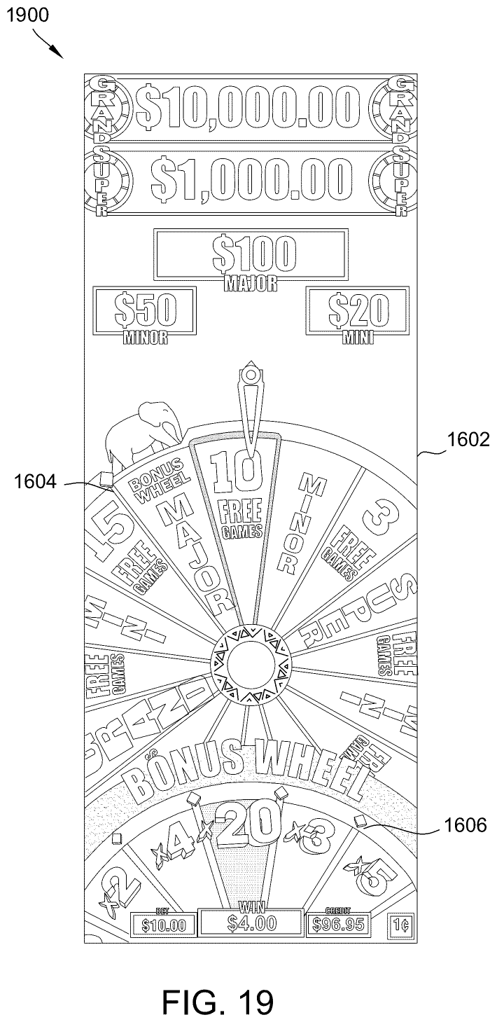

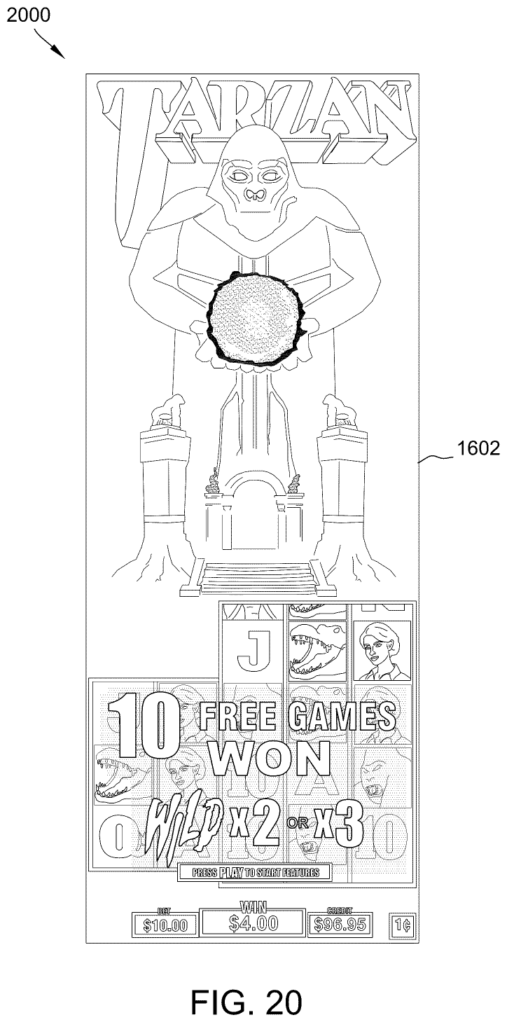

After the completion of spinning the multiplier wheel 1606 and increasing the amount of the jackpot by the multiplier, the bonus feature game reverts back to the main wheel 1604 where the player is again prompted to spin the main wheel. Only when the player lands on a number of free games (shown in FIG. 19) from the main wheel does this bonus feature game exit this screen and enter the free spin feature. The screen display 1900 depicts an example of the main wheel 1604 landing on 10 free games. The processor 204 subsequently controls the UI 1602 to enter the free spin feature. The screen display 2000 of FIG. 20 depicts a transition screen displayed on the UI 1602 between the bonus wheel feature and the free spin feature of the bonus game.

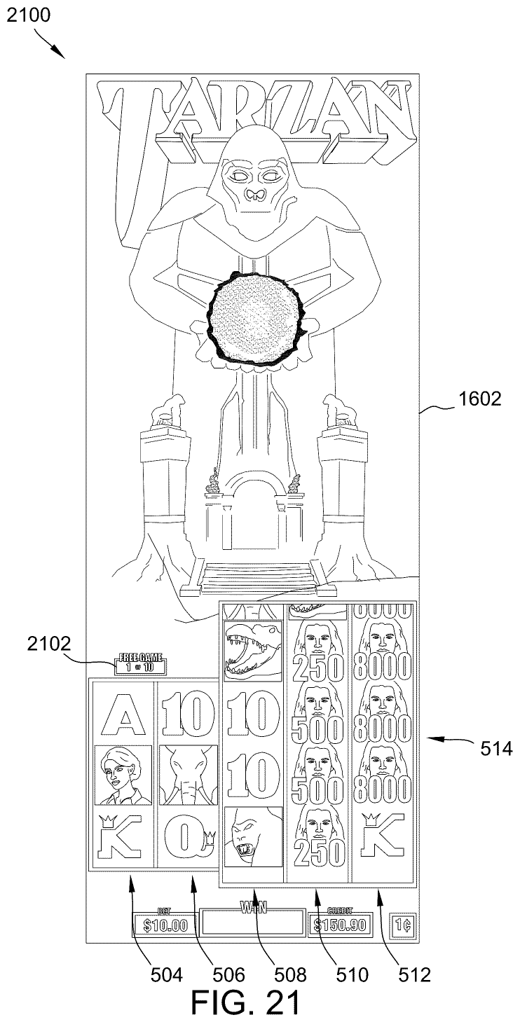

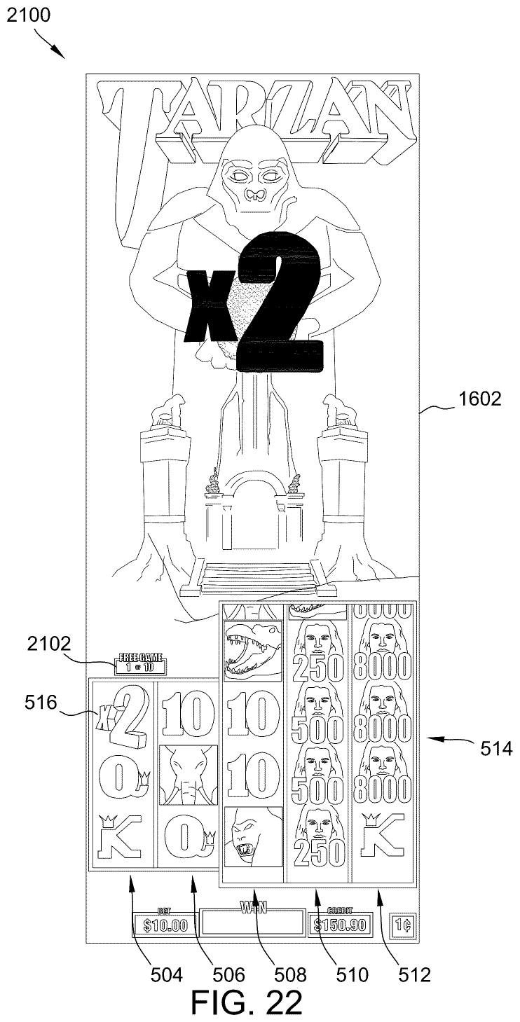

Upon entering the free spin feature above, the game rules are substantially the same as the base game and the processor 204 generally follows the process 400 of FIGS. 4A-4B for each spin of the free spin feature. FIG. 21 is a screen display 2100 depicting the free spin feature provided on the UI 1602. As shown, the UI 1602 is controlled to display the matrix 514 with the reels 504-512 as described above. The reels 504-512 are spun and stopped, with potential expansion of the second set of reels 508-512 as described above. A free spin counter 2102 may also be displayed to visually indicate the number of free spins remaining in the free spin feature (incrementing or decrementing with each spin). The game rules are substantially the same as the base game, with the exception that each instance of a WILD symbol 516 triggers an RNG outcome or a lookup to determine a multiplier value for the WILD symbol. This is shown in the screen display 2200 of FIG. 22, where the WILD symbol 516 on the first reel 506 has become a 2× WILD symbol. In the example implementation, the lookup for each WILD symbol selects between a 2× WILD or a 3× WILD. The multiplier value of the WILD symbol is played out and evaluated as a “wild” and also applies a 2× multiplier to the award of the outcome of the spin in which the WILD symbol appears.

Two other different rules are applied during the free spin feature game. First, where a WILD symbol 516 is provided a multiplier value, that multiplier value is applied to the evaluation of the spin outcome for the purposes of determining an award but is not applied to a check that may be performed at operation 428 by the processor 204 in determining whether the tallest height expansion determined at operation 414 will be applied. That is, the award must still be 5× the bet level to satisfy that condition, prior to application of the multiplier values associated with the WILD symbols 516 on the first set of reels 504, 506. Second, a free spin reset is applied during the feature game based on the appearance of a triggering number of the bonus game symbols 518. In the example implementation, only two bonus game symbols 518 need to appear in a free spin outcome to trigger the free spin reset, which is 5 free spins in this example. For the purpose of determining the check at operation 428, the processor 204 may determine whether the outcome of a free spin includes two bonus game symbols 518, rather than the three bonus game symbols 518 used for the check at operation 428 in the base game. The free spin feature completes when all free spin have been played, and no free spin reset is applied. Then, the total wins are summed and the game reverts back to the base game, transitioning to the base game UI 502.

A computer, controller, or server, such as those described herein, includes at least one processor or processing unit and a system memory. The computer, controller, or server typically has at least some form of computer readable non-transitory media. As used herein, the terms “processor” and “computer” and related terms, e.g., “processing device”, “computing device”, and “controller” are not limited to just those integrated circuits referred to in the art as a computer, but broadly refers to a microcontroller, a microcomputer, a programmable logic controller (PLC), an application specific integrated circuit, and other programmable circuits “configured to” carry out programmable instructions, and these terms are used interchangeably herein. In the embodiments described herein, memory may include, but is not limited to, a computer-readable medium or computer storage media, volatile and nonvolatile media, removable and non-removable media implemented in any method or technology for storage of information such as computer readable instructions, data structures, program modules, or other data. Such memory includes a random access memory (RAM), computer storage media, communication media, and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

As indicated above, the process may be embodied in computer software. The computer software could be supplied in a number of ways, for example on a tangible, non-transitory, computer readable storage medium, such as on any nonvolatile memory device (e.g., an EEPROM). Further, different parts of the computer software can be executed by different devices, such as, for example, in a client-server relationship. Persons skilled in the art will appreciate that computer software provides a series of instructions executable by the processor.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A gaming system comprising:
a processor; and
a memory storing instructions thereon which, when executed by the processor, cause the processor to:
control a display device to display a play instance of an electronic game including a first subset of reels and a second subset of reels;
cause display of a first set of symbols on the first subset of reels;
determine that a first trigger condition stored in the memory is satisfied based on the first set of symbols, wherein the first trigger condition is a pre-defined symbol type appearing on each reel of the first subset of reels; and
randomly determine whether to cause display of the same symbols on each reel of the first subset of reels.

2. The gaming system of claim 1, wherein in response to determining that the first trigger condition is satisfied and determining to cause display of the same symbols on each reel of the first subset of reels, the instructions, when executed, cause the processor to:
control the display device to increase a number of rows for the second subset of reels; and
cause display of a second set of symbols on the second subset of reels after increasing the number of rows.

3. The gaming system of claim 2, wherein the instructions, when executed, further cause the processor to randomly determine the increased number of rows for the second subset of reels when the first trigger condition is satisfied.

4. The gaming system of claim 3, wherein the increased number of rows for the second subset of reels is randomly selected from a range between a shortest expanded reel height and a tallest expanded reel height.

5. The gaming system of claim 4, wherein the instructions, when executed, further cause the processor to implement a check on the increased number of rows for the second subset of reels when the first trigger condition is satisfied and the tallest expanded reel height is selected, wherein the check includes determining whether one or more win conditions of the play instance is satisfied.

6. The gaming system of claim 5, wherein, in response to the one or more win conditions not being satisfied as determined by the check, the instructions, when executed, further cause the processor to control the display device to increase the number of rows for the second subset of reels a reel height that is shorter than the tallest expanded reel height.

7. The gaming system of claim 2, wherein the instructions, when executed, further cause the processor to evaluate the first set of symbols and the second set of symbols for one or more bonus game symbols.

8. The gaming system of claim 7, wherein the instructions, when executed, further cause to processor to initiate a bonus feature game when a triggering number of bonus game symbols are included in one or both of the first set of symbols and the second set of symbols.

9. The gaming system of claim 2, wherein the instructions, when executed, further cause the processor to evaluate the second set of symbols for one or more cash on reel symbols.

10. The gaming system of claim 9, wherein in response to one or more cash on reel symbols included in the second set of symbols, the instructions, when executed, further cause the processor to determine whether to award credit values associated with the cash on reel symbols based on the first trigger condition being satisfied and at least one second trigger condition being satisfied.

11. The gaming system of claim 10, wherein the second trigger condition is one or more of the cash on reel symbols appearing on a predetermined reel of the second subset of reels.

12. The gaming system of claim 11, wherein cash on reel symbols appearing on the predetermined reel are associated with credit values selected from a lower range of credit values than credit values associated with cash on reel symbols appearing on the other reels of the second subset of reels.

13. A non-transitory computer-readable medium containing instructions stored thereon, which when executed by a processor, cause the processor to:
control a display device to display a play instance of an electronic game including a first subset of reels and a second subset of reels;
control the display device to display a first set of symbols on the first subset of reels;
determine that a first trigger condition stored in memory is satisfied based on the first set of symbols, wherein the first trigger condition is a pre-defined symbol type appearing on each reel of the first subset of reels; and
randomly determine whether to control the display device to display the same symbols on each reel of the first subset of reels.

14. The non-transitory computer-readable medium of claim 13, wherein in response to determining that the first trigger condition is satisfied and determining to control the display device to display the same symbols on each reel of the first subset of reels, the instructions, when executed, cause the processor to:
control the display device to increase a number of rows for the second subset of reels; and
control the display device to display a second set of symbols on the second subset of reels after increasing the number of rows.

15. The non-transitory computer-readable medium of claim 14, wherein the instructions, when executed, further cause the processor to:
randomly determine the increased number of rows for the second subset of reels when the first trigger condition is satisfied, wherein the increased number of rows for the second subset of reels is randomly selected from a range between a shortest expanded reel height and a tallest expanded reel height;
implement a check on the increased number of rows for the second subset of reels when the first trigger condition is satisfied and the tallest expanded reel height is selected, wherein the check includes determining whether one or more win conditions of the play instance is satisfied; and
in response to the one or more win conditions not being satisfied as determined by the check, control the display device to increase the number of rows for the second subset of reels a reel height that is shorter than the tallest expanded reel height.

16. The non-transitory computer-readable medium of claim 14, wherein the instructions, when executed, further cause the processor to:
evaluate the first set of symbols and the second set of symbols for one or more bonus game symbols; and
initiate a bonus feature game on the display device when a triggering number of bonus game symbols are included in one or both of the first set of symbols and the second set of symbols.

17. The non-transitory computer-readable medium of claim 14, wherein the instructions, when executed, further cause the processor to:
evaluate the second set of symbols for one or more cash on reel symbols; and
in response to one or more cash on reel symbols included in the second set of symbols, determine whether to award credit values associated with the cash on reel symbols based on the first trigger condition being satisfied and at least one second trigger condition being satisfied, wherein the second trigger condition is one or more of the cash on reel symbols appearing on a predetermined reel of the second subset of reels, and wherein cash on reel symbols appearing on the predetermined reel are associated with credit values selected from a lower range of credit values than credit values associated with cash on reel symbols appearing on the other reels of the second subset of reels.

18. A computer-implemented method comprising:
controlling a display device to display a play instance of an electronic game including a first subset of reels and a second subset of reels;
controlling the display device to display a first set of symbols on the first subset of reels;
determining that a first trigger condition stored in memory is satisfied based on the first set of symbols, wherein the first trigger condition is a pre-defined symbol type appearing on each reel of the first subset of reels; and
randomly determining whether to control the display device to display the same symbols on each reel of the first subset of reels.

19. The computer-implemented method of claim 18, further comprising:
in response to determining that the first trigger condition is satisfied and determining to control the display device to display the same symbols on each reel of the first subset of reels:
controlling the display device to increase a number of rows for the second subset of reels; and
controlling the display device to display a second set of symbols on the second subset of reels after increasing the number of rows;
randomly determining the increased number of rows for the second subset of reels when the first trigger condition is satisfied, wherein the increased number of rows for the second subset of reels is randomly selected from a range between a shortest expanded reel height and a tallest expanded reel height;
implementing a check on the increased number of rows for the second subset of reels when the first trigger condition is satisfied and the tallest expanded reel height is selected, wherein the check includes determining whether one or more win conditions of the play instance is satisfied; and
in response to the one or more win conditions not being satisfied as determined by the check, controlling the display device to increase the number of rows for the second subset of reels a reel height that is shorter than the tallest expanded reel height.

20. The computer-implemented method of claim 19, further comprising:
evaluating the second set of symbols for one or more cash on reel symbols; and
in response to one or more cash on reel symbols included in the second set of symbols, determining whether to award credit values associated with the cash on reel symbols based on the first trigger condition being satisfied and at least one second trigger condition being satisfied, wherein the second trigger condition is one or more of the cash on reel symbols appearing on a predetermined reel of the second subset of reels, and wherein cash on reel symbols appearing on the predetermined reel are associated with credit values selected from a lower range of credit values than credit values associated with cash on reel symbols appearing on the other reels of the second subset of reels.
